(19) United States
(12) Patent Application Publication
(10) Pub. No.: US 2023/0196243 A1
(43) Pub. Date: Jun. 22, 2023

(54) FEATURE DEPRECATION ARCHITECTURES FOR DECISION-TREE BASED METHODS

(71) Applicant: PayPal, Inc., San Jose, CA (US)

(72) Inventors: Itay Margolin, Pardesiya (IL); Roy Lothan, Tel Aviv (IL)

(21) Appl. No.: 17/557,693

(22) Filed: Dec. 21, 2021

(51) Int. Cl. G06Q 10/06; G06N 5/00

(52) U.S. Cl. CPC G06Q 10/0635; G06N 5/003

(57) ABSTRACT

Various techniques for determining risk assessment predictions and decisions are disclosed. Certain disclosed techniques include the implementation of decision-tree based models in determining predictions of risk for an operation based on an input dataset. The disclosed techniques include pruning decision trees to compensate for deprecation of variables from the input dataset. Decision trees may be pruned at nodes associated with the deprecated variables to inhibit the decision trees from breaking down during operation on an input dataset having deprecated variables.

### BACKGROUND

### Technical Field

This disclosure relates generally to managing deprecation of features in machine learning algorithms and decision tree structures, according to various embodiments.

### Description of the Related Art

Data science models that implement machine learning algorithms (e.g., neural networks, Random Forest, and decision-tree based models) to provide predictions are dependent on numerous variables (e.g., features) that are obtained over time. For instance, models that predict risk have variables that can number in the thousands or the tens of thousands. With these high numbers of variables, maintenance of the variables plays an important role in maintaining prediction accuracy for the models. For example, these models may be impacted by the deprecation of variables from the models. Variables may be deprecated based on changes in information available, discontinued use of information, or other factors.

### BRIEF DESCRIPTION OF THE DRAWINGS

The following detailed description makes reference to the accompanying drawings, which are now briefly described.

FIG. 1 is a block diagram of a system configured to determine a risk assessment decision using neural networks, according to some embodiments.

FIG. 2 is a block diagram of a neural network training module, according to some embodiments.

FIG. 3 depicts an example of a training flow for a neural network.

FIG. 4 depicts an example of an operational flow for the neural network trained in FIG. 3.

FIG. 5 depicts a training flow for a neural network, according to some embodiments.

FIG. 6 depicts an operational flow for a trained neural network module without deprecated variables.

FIG. 7 depicts an operational flow for a trained neural network module with deprecated variables.

FIG. 8 is a block diagram of a risk assessment decision determination system that handles variable deprecation, according to some embodiments.

FIG. 9 is a block diagram of a system configured to determine a risk assessment decision using decision trees, according to some embodiments.

FIG. 10 depicts an example of an ensemble of decision trees, according to some embodiments.

FIG. 11 is a block diagram of a system configured to determine a risk assessment decision using decision trees where deprecated variable information is independent of the request, according to some embodiments.

FIG. 12 depicts an example of an ensemble of decision trees being operated on by a decision tree pruning module, according to some embodiments.

FIG. 13 depicts the ensemble from FIG. 12 after the pruning operation has been completed, according to some embodiments.

FIG. 14 depicts a block diagram of a decision tree module operating on both pruned and unpruned decision trees, according to some embodiments.

FIG. 15 is a flow diagram illustrating a method for determining a risk assessment decision, according to some embodiments.

FIG. 16 is a flow diagram illustrating another method for determining a risk assessment decision, according to some embodiments.

FIG. 17 is a block diagram of one embodiment of a computer system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that an element is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z). In some situations, the context of use of the term “or” may show that it is being used in an exclusive sense, e.g., where “select one of x, y, or z” means that only one of x, y, and z are selected in that example.

In the following description, numerous specific details are set forth to provide a thorough understanding of the disclosed embodiments. One having ordinary skill in the art, however, should recognize that aspects of disclosed embodiments might be practiced without these specific details. In some instances, well-known, structures, computer program instructions, and techniques have not been shown in detail to avoid obscuring the disclosed embodiments.

### DETAILED DESCRIPTION

The present disclosure is directed to various techniques related to the application of data science models to datasets with large numbers of variables (e.g., features). In various embodiments, machine learning algorithms (e.g., neural network models) or decision-tree based methods (e.g., decision tree ensembles such as Random Forest and XGBoost) may be applied to various datasets to provide predictions based on data input from the datasets. For example, a dataset may include variables related to assessment of risk for an operation associated with a user. Predictions of risk provided by the various models may then be utilized in making a risk assessment decision for the operation associated with the user. As used herein, “risk assessment” refers to an assessment of risk associated with conducting an operation. In this context, “an operation” can be any tangible or non-tangible operation involving one or more sets of data associated with a user or a group of users for which there may be some potential of risk. Examples of operations for which risk assessment decisions can be made include, but are not limited to, transactional operations, investment operations, insurance operations, vehicle control operations, and robotic operations. As specific examples, risk of fraud may be assessed for transactional operations, risk of failure may be assessed for investment operations, and risk of a vehicle crash may be assessed in vehicle control operations (such as autonomous vehicle operations).

Models that make predictions of risk include large numbers of variables, often in the thousands or tens of thousands. Accordingly, maintenance of these variables plays a large role in prediction accuracy due to the dynamic nature of data collection. For example, data availability for variables may be dropped due to changes in regulatory compliance, suspension of legacy data sources, high maintenance costs for storing data, limited storage space, or possibly due to failure in upstream data sources (which renders data no longer available). To accommodate data no longer being available for certain variables, the variables may be deprecated from the models. Deprecation of variables from the above-described models may, however, lead to decreased accuracy or breakage of the models.

Problems associated with the deprecation of variables may be costly and time consuming to overcome due to the large number of variables associated with these models. For example, one potential solution is to train a model (such as a machine learning algorithm) from scratch with the deprecated variables removed from the model. Doing such training, however, is time consuming and costly. Further, for a model with hundreds or thousands of variables (e.g., features), the deprecation rate of different features is significantly high, therefore requiring extensive maintenance as each time a feature is deprecated, the model is trained, monitored, and evaluated all over again. In addition to the time cost in training the model all over again, when a new model is deployed, there is no certainty in the calibration of the model unlike the previous version. Thus, frequent updates can provide an unsettling customer experience and inconsistent (possibly arbitrary) decisions.

Another option for dealing with the deprecation of variables is to train models with fewer features in advance. For instance, multiple models with fewer features may be trained in advance based on potential for deprecated variables. Training multiple models with fewer features reduces the complexity and required maintenance for these models but at the cost of performance and accuracy in providing predictions. Additionally, it may not be possible to cover every scenario where features are deprecated such as when multiple features are deprecated at the same time.

The present disclosure contemplates various techniques that provide robust models that self-compensate when features (e.g., variables) are deprecated from the models. These robust models may be implemented in making risk predictions for risk assessment decisions without the need for retraining the models or training multiple models in advance. One embodiment described herein is implemented for neural networks and has two broad components: 1) training a neural network by dropping some variables from an input space of the neural network during training, and 2) determining, from the trained neural network, a risk prediction based on a dataset associated with an operation. In various embodiments, the risk prediction output from the trained neural network is adjusted according to a dropped variable factor. In one embodiment, the dropped variable factor corresponds to the number of variables dropped from the input space during training divided by the total number of variables used in the input space. In some embodiments, one or more variables have been deprecated from the dataset assessed by the trained neural network. In such embodiments, the risk prediction output from the trained neural network may further be adjusted by a deprecated variable factor. The deprecated variable factor may be the total number of variables before deprecation divided by the number of variables after deprecation.

Another embodiment described herein is implemented for decision tree models (e.g., decision tree ensembles) and has two broad components: 1) pruning a branch of a decision tree based on a deprecated variable, and 2) determining, from the pruned decision tree, a risk prediction based on a dataset associated with an operation. In various embodiments, the branch of the decision tree is pruned in response to the dataset associated with the operation having the deprecated variable (e.g., the variable has been deprecated from the dataset provided to the decision tree). In some embodiments, the branch is pruned after an intermediate node that provides a decision result based on the deprecated variable. The intermediate node may be replaced with a decision result that is based on a majority of previous decision results at the intermediate node. Branches of the decision tree that do not have any nodes associated with the deprecated variable are left unpruned. Inputting the dataset into the decision tree then provides distinct decision results at output nodes in the decision tree. These distinct decision results may then be combined to provide a risk prediction output for the input dataset.

In short, the present inventors have recognized the benefits of providing data science models (such as neural networks and decision trees) that are robust and can compensate for deprecated variables without retraining or reforming the entire model. Implementing the disclosed robust models may provide more accurate and consistent risk assessment decisions in view of deprecated variables. Additionally, these robust models maintain performance for the risk assessment decisions without the need for complicated or time-consuming maintenance operations. The various models will now be described herein beginning with the neural network (e.g., machine learning algorithm) models.

### Neural Network Models

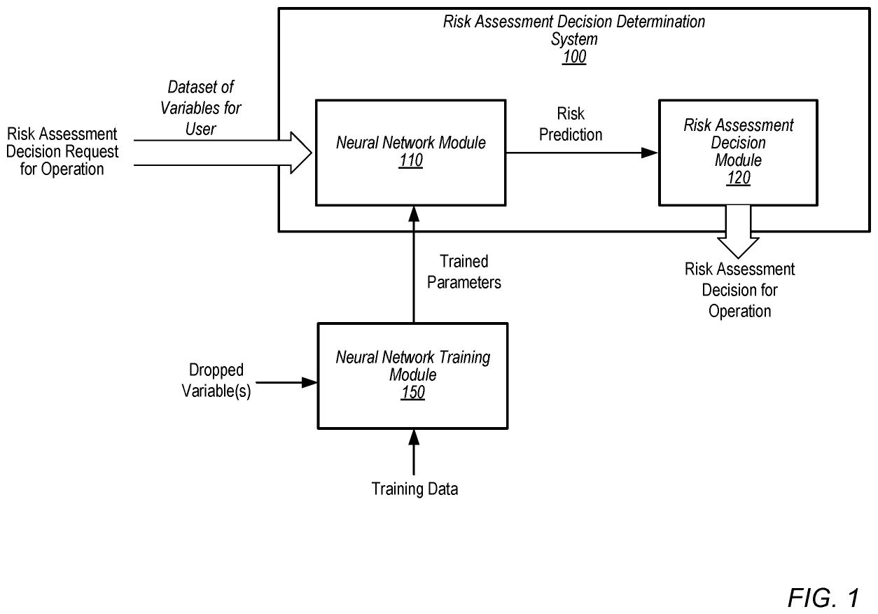

FIG. 1 is a block diagram of a system configured to determine a risk assessment decision using neural networks, according to some embodiments. In various embodiments, system 100 is a computing system. As used herein, the term “computing system” refers to any computer system having one or more interconnected computing devices. Note that generally, this disclosure may include various examples and discussion of techniques and structures within the context of a “computer system.” Note that all these examples, techniques, and structures are generally applicable to any computing system that provides computer functionality. The various components of system 100 (e.g., computing devices) may be interconnected. For instance, the components may be connected via a local area network (LAN). In some embodiments, the components may be connected over a wide-area network (WAN) such as the Internet.

In the illustrated embodiment, system 100 includes neural network module 110 and risk assessment decision module 120. In various embodiments, neural network module 110 receives a dataset of variables for user along with a request for a risk assessment decision for an operation associated with the user. From the dataset, neural network module 110 may determine a risk prediction that is provided to risk assessment decision module 120. As one example, the risk prediction may be a probability between 0 and 1 of risk associated with the operation with 0 being no risk and 1 being the highest risk. Risk assessment decision module 120 may then assess the risk prediction and make risk assessment decision for the operation.

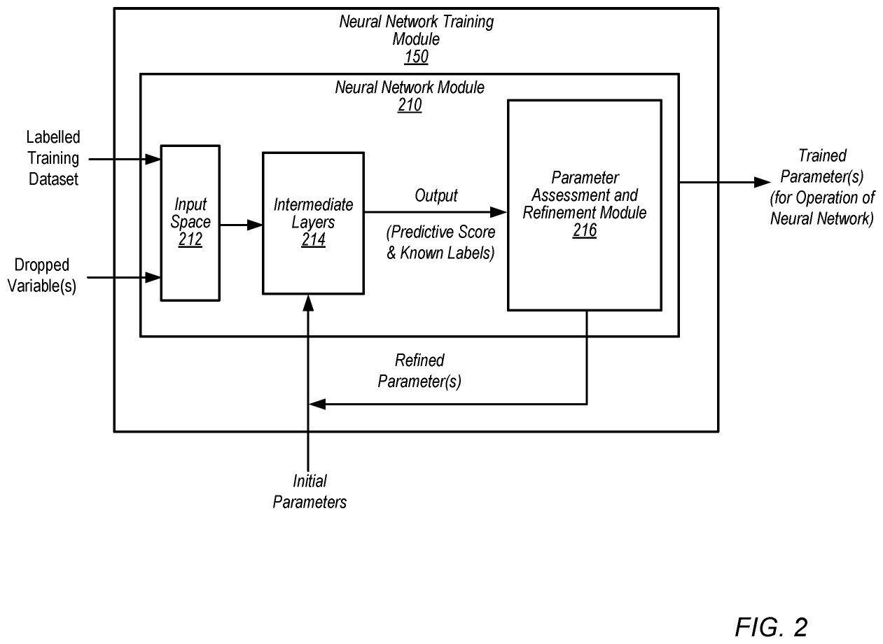

In certain embodiments, neural network module 110 is a trained neural network module (e.g., trained machine learning algorithm) that applies trained parameters determined by neural network training module 150. As shown in FIG. 1, neural network training module 150 may determine trained parameters based on training data and dropped variable(s). FIG. 2 is a block diagram of neural network training module 150, according to some embodiments. In the illustrated embodiment, neural network training module 150 includes neural network module 210. Neural network module 210 may implement one or more machine learning algorithms in determining a predictive score output from input data.

In certain embodiments, neural network module 210 includes input space 212, intermediate layers 214, and parameter assessment and refinement module 216. For training of neural network module 210, a labelled training dataset is provided to input space 212. The labelled training dataset may include, for example, a plurality of variables having known labels for prediction or probabilities included with the variables. The input variables are then provided to intermediate layers 214. At intermediate layers 214, neural network module 210 applies parameters (e.g., classifiers) to determine an output (e.g., a predictive score) based on the input variables. In various embodiments, initial parameters are applied in intermediate layers 214. These initial parameters may be starting points for refinement of the parameter(s) to train neural network module 150.

As described, intermediate layers 214 may implement various steps of encoding, embedding, or applying functions to provide a predictive score output based on the input variables and applied parameters. In various embodiments, the predictive score output is provided along with the known labels for the input variables to parameter assessment and refinement module 216. Parameter assessment and refinement module 216 may assess the predictive output compared to the known labels and determine refinements in the parameters or provide trained parameter output based on the comparison. Accordingly, between input space 212, intermediate layers 214, and parameter assessment and refinement module 216, neural network module 210 may fine tune (e.g., “train”) itself and refine its parameter(s) to provide accurate predictions of categories for the labelled training dataset input into the neural network module. After one or more refinements (e.g., training steps), one or more trained parameters may be determined by neural network module 210. The trained parameter(s) (e.g., classifier(s)) may be, for example, operating parameters for neural network module 210 that generate a predictive score that is as close to the score input on the known labels as possible. These trained parameters may then be implemented by neural network module 110 (shown in FIG. 1) or another machine learning algorithm to classify datasets and provide a predictive output (e.g., a risk prediction output).

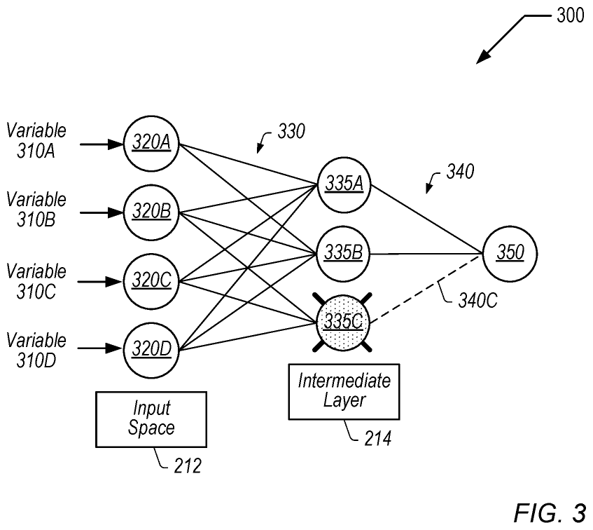

Dropout is a technique often implemented during training of neural networks to make more robust neural networks. Dropout is implemented to reduce the overfitting of a neural network by “shutting down” random numbers of neurons during the training of the neural network. Typically, dropout is implemented in neural network training by dropping an intermediate layer during one or more training steps. FIG. 3 depicts an example of a training flow for a neural network. In the illustrated example of training flow 300, four variables 310A-D are input at nodes 320A-D, respectively, in input space 212. These variables are then applied along edges 330 from nodes 320A-D to nodes 335A-C in intermediate layer 214. Nodes 335A-C may represent the various intermediate layers of the neural network. Edges 340 from nodes 335A-C then converge at output 350 with the output being the predictive score output of the neural network.

To provide dropout in training flow 300, various training steps may include dropping one of the intermediate layers. In various embodiments, the intermediate layers may be dropped during random periods of training. In the illustrated example, the intermediate layer represented by node 335C is being dropped randomly during training. With the dropping of node 335C, its downstream edge (e.g., edge 340C) is ignored in output 350. Thus, ⅓ of the neurons (and ⅓ of the edges in a fully connected network) are ignored. With the random ignoring of intermediate layers, the neural network can be trained to be more robust. The training involving dropping of intermediate layers does not, however, accommodate (e.g., provide robustness) for deprecation of variables from datasets provided as input to the neural network. Thus, if variables are later deprecated (e.g., removed) from datasets provided as input to the neural network, the neural network may have decreased accuracy or even break when trying to provide a predictive output.

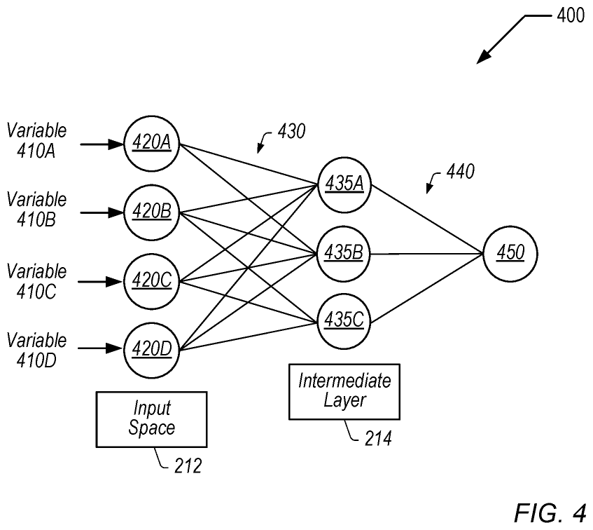

FIG. 4 depicts an example of an operational flow for the neural network trained in FIG. 3. Operational flow 400 may be a flow where the neural network provides an inference (e.g., prediction) on an input dataset of variables. For instance, operational flow 400 may be the flow of the neural network during operation in providing risk predictions with variables 410A-C, input nodes 420A-C, and intermediate nodes 435A-C). As shown in FIG. 4, during operation, all neurons (e.g., all edges 440) from all the intermediate layers (e.g., all nodes 435A-C) are active and provided to output 450. In various embodiments, output 450 may be multiplied by a scaling factor to keep the scale of the output coherent because of the dropping of the intermediate layer during training. For example, since ⅓ of the neurons (and ⅓ of the edges in a fully connected network) were ignored during training, output 450 may be multiplied by a factor of ⅔ (e.g., 1⅓). As described above, if variables are deprecated from the input dataset, the neural network shown in FIG. 4 may not be capable of providing an accurate prediction or could even breakdown in trying to provide a predictive output.

To overcome the problems with networks trained using embodiments along the lines of the example in FIGS. 3 and 4, the present inventors have recognized that a revised dropout process that drops variables from the input space during training of the neural network may provide a neural network that is more robust when variables are deprecated from input datasets to the neural network. Turning back to FIG. 2, in certain embodiments, one or more dropped variables are implemented in input space 212. In various embodiments, the dropped variables may be variables that are likely to be deprecated later during operation of the neural network. As described above, variables may be deprecated due to new information becoming available or a source of variable information being no longer available as well as other factors. In risk prediction, some variables are more likely to be deprecated than others while other variables are primary variables that are very unlikely to be deprecated. Thus, the dropped variables implemented in input space 212 may be the variables that are more likely to be deprecated while the primary variables are not dropped from the input space.

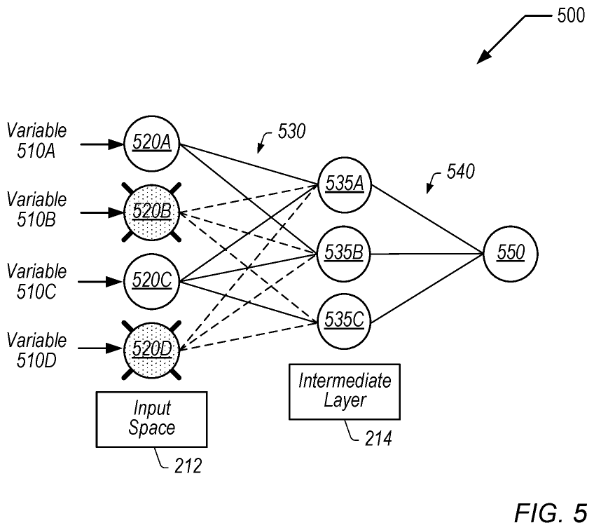

FIG. 5 depicts a training flow for a neural network, according to some embodiments. Training flow 500 may be a training flow implemented by neural network 210, shown in FIG. 2. In the illustrated embodiment of FIG. 5, training flow 500 has four variables 510A-D being input at nodes 520A-D, respectively, in input space 212. To train the neural network for the possible deprecation of variables during operation of the neural network, in various embodiments, one or more variables 510 and their corresponding nodes 520 in input space 212 are dropped during training of the neural network. Variables 510 that are dropped from input space 212 correspond to the dropped variables shown in FIG. 2. Dropping a variable during training may include, for example, setting the input value of the variable to be 0 (zero) in input space 212 during a training step.

In certain embodiments, a set number of variables are randomly dropped from input space 212 during each training step for the neural network. Input space 212 has a given set of features and a dropout rate for variables from the input space may be specified (e.g., a number between 0 and 1 specifying the fraction of variables to be dropped during each training step). For example, in the illustrated embodiment of FIG. 5, input space 212 has 4 input variables and the specified dropout rate is 0.5 (such that 2 variables are dropped during each training step). As shown in FIG. 5, one embodiment of a training step may have variables 510B and 510D dropped (e.g., their input values set to zero). As described below, dropping these variables during the training step forces the neural network to train with the variables ignored from input space 212.

In various embodiments, the variables dropped during a training step are randomly selected according to the specified dropout rate. For example, any two of the four variables 510A-D are randomly dropped during each training step based on the specified dropout rate of 0.5. Thus, the variables dropped may vary from training step to training step in order to train the neural network to robustly operate in view of different variables being later deprecated from the input space of the neural network.

In some contemplated embodiments, random selection of variables for dropping from the input space during training may be limited to variables that can or are likely to be deprecated during in service operation of the neural network. For instance, primary variables may be inhibited from being dropped during training of the neural network. Primary variables may be, for example, variables that are primary or essential to operations being conducted by the neural network and thus very unlikely to be deprecated.

In some embodiments, the likelihood of variables to be deprecated may be accounted for in the selection (e.g., random selection) of variables being dropped during training of the neural network. For instance, each variable may have a value corresponding to its likelihood of being deprecated. As an example, the deprecation likelihood values for the variables in FIG. 5 may be 0 for variable 510A, 0.9 for variable 510B, 0.3 for variable 510C, and 0.8 for variable 510D. Accordingly, these values may be implemented to “bias” the random selection of dropped variables towards variables with higher values. For example, variable 510B has a higher probability of being dropped than variable 510D, which as a higher probability of being dropped than variable 510C, while variable 510A is not dropped during any training step. An overall specified dropout rate may also be determined from these likelihoods based on a mean value of all the individual values of deprecation likelihood (e.g., the specified dropout rate may be ((0+0.9+0.3+0.8)/4=0.5).

FIG. 5, as described above, depicts one contemplated embodiment of a training step where variables 510B and 510D are dropped and their values set to zero for the training step. Accordingly, node 520B and node 520D are ignored in input space 212 during training flow 500. Ignoring these node 520B and node 520D then causes edges 530 (and the corresponding neurons) from these nodes to be ignored in intermediate layer 214. The ignored edges 530 are shown as dashed lines in FIG. 5. All the intermediate layers (e.g., intermediate nodes 535A-C), however, remain active in intermediate layer 214. The intermediate layer 214, however, is now trained to compensate for the lack of input edges from node 520B and node 520D. For example, in the illustrated embodiment, intermediate layer 214 is forced to train with ½ of the variables (and their corresponding neurons) being removed from its decision process. Nodes 353A-C then all provide edges 540 to output 550.

In various embodiments, training flow 500, shown in FIG. 5, is implemented in neural network training module 150 for the training and determination of trained parameters for neural network module 210, shown in FIG. 2. Turning back to FIG. 1, these trained parameters from neural network training module 150 may be implemented by neural network 110. Accordingly, neural network module 110 is now trained to operate robustly on the dataset of variables provided as input to the neural network module. Robust operation is provided as neural network module 110 can provide accurate predictions on input datasets regardless of whether the datasets have any deprecated variables or not.

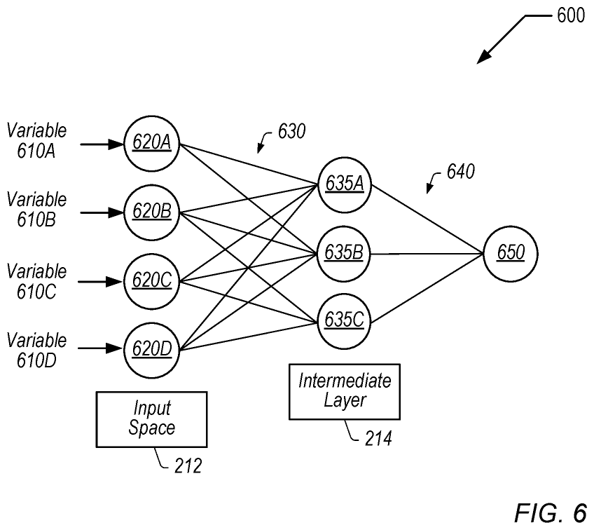

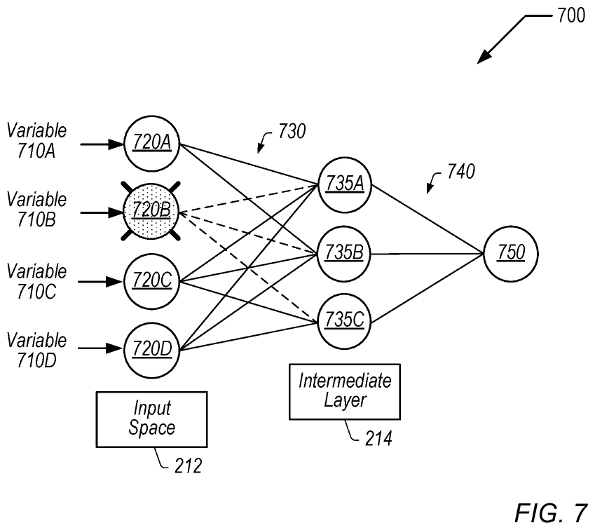

The robust operations of neural network module 110 are exemplified by the operational flows depicted in FIGS. 6 and 7. FIG. 6 depicts an operational flow for trained neural network module 110 without deprecated variables. FIG. 7 depicts an operational flow for trained neural network module 110 with deprecated variables. Turning first to FIG. 6, in operational flow 600, there is no deprecation of variables from the input dataset. Thus, all variables 610A-D and input nodes 620A-D are active and all edges 630 are provided to intermediate nodes 635A-C in intermediate layer 214. Similarly, all intermediate nodes 635A-C are active and all edges 640 and their neurons are provided to output 650.

In various embodiments, since operational flow 600 is based on the training shown in FIG. 5 (e.g., training flow 500), output 650 is adjusted (e.g., scaled) by a dropped variable factor to keep the scale of the output coherent. In certain embodiments, output 650 is adjusted by multiplying the output by the dropped variable factor. The dropped variable factor may be based on the number of variables dropped during training. For example, the dropped variable factor may be determined as: 1−(the fraction of variables dropped during training). This fraction is, for instance, a number of variables in the input dataset dropped during training divided by a total number of variables in the input dataset. Thus, for training flow 500, shown in FIG. 5, the dropped variable factor is determined as 1½=½ since 2 out of the 4 input variables are dropped during training. Accordingly, output 650 in FIG. 6 may be multiplied by ½ to get the final output on a coherent scale.

Turning now to FIG. 7, operational flow 700 includes variables 710A-D, input nodes 720A-D, edges 730, intermediate nodes 735A-C, edges 740, and output node 750. In operational flow 700, variable 710B is deprecated and thus node 720B is “ignored” in the operational flow. During operational flow 700 (e.g., the inference time of the neural network), any input value for an “ignored” variable is replaced with a predetermined value (such as −1 or any other desired value). For example, variable 710B may have a predetermined value of −1 due to deprecation of the variable. Accordingly, edges 730 (shown by the dashed lines) from node 720B are ignored by nodes 735A-C in intermediate layer 214. With edges 730 being ignored, edges 740 from nodes 735A-C providing output 750 are determined with less data. To compensate for the reduced amount of data, in some embodiments, output 750 is adjusted (e.g., scaled) by a deprecated variable factor. The deprecated variable factor is based on the number of variables deprecated in the input dataset (e.g., in input space 212). In one embodiment, the deprecated variable factor is determined as the total number of variables before deprecation divided by the number of variables after deprecation. Thus, in the illustrated embodiment, the deprecated variable factor is 4 divided by 3 or 4/3.

In certain embodiments, output 750 is multiplied by both the dropped variable factor and the deprecated variable factor to determine a final, scaled predictive output. For example, in the embodiment depicted in FIG. 7, output 750 may be multiplied by ½ and 4/3 to get a scaled, coherent output value that compensates for the ignored neurons during both training and operation of the neural network. As shown by operational flows 600 and 700 in FIGS. 6 and 7, respectively, neural network module 110 (shown in FIG. 1) can provide accurate predictions regardless of whether the input dataset has deprecated variables or not. Accordingly, implementation of neural network module 110 in risk assessment decision determination system 100 provides the system with a robust mechanism for determining risk predictions and risk assessment decisions on datasets provided to the system.

Turning back to FIG. 1, in some embodiments, the dataset of variables for the user that is provided along with the risk assessment decision request has variables already deprecated from the dataset. For instance, as one example, the dataset of variables may be variables stored in a database or other storage system. At some point in time, variables may have been deprecated (e.g., removed) from the database and thus when risk assessment decision determination system 100 accesses the dataset, the deprecated variables are no longer available. As another example, the dataset of variables for the user may include user provided data (e.g., through a web interface). Deprecation may then occur when the web interface no longer asks for certain data from the user. In either of these example instances, neural network module 110 may operate along the lines of the embodiment of operational flow 700, depicted in FIG. 7, and the risk prediction is multiplied by the dropped variable factor and the deprecated variable factor in response to the variable(s) being deprecated from the input dataset.

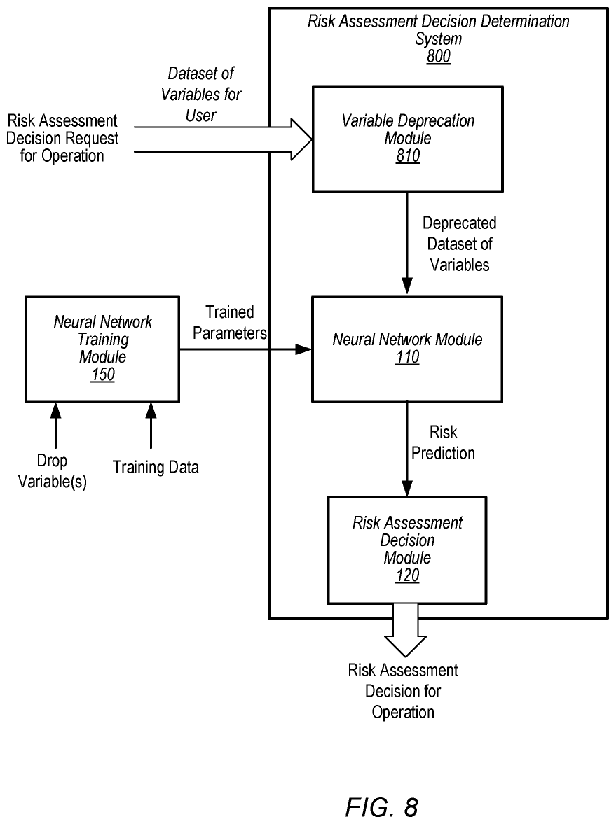

Various embodiments may also be contemplated where risk assessment decision determination system 100 handles deprecation of variables from the dataset. For example, risk assessment decision determination system 100 may be responsible for responding to changes in regulatory compliance or recognition that incomplete data is being received. FIG. 8 is a block diagram of a risk assessment decision determination system 800 that handles variable deprecation, according to some embodiments. In the illustrated embodiment, risk assessment decision determination system 800 includes variable deprecation module 810. Variable deprecation module 810 may handle deprecation of variables from an incoming dataset based on the various factors described herein (e.g., changes in regulatory compliance for determining risk assessment decisions). After deprecation of variables, the deprecated dataset may be provided to neural network module 110, which provides a risk prediction output to risk assessment decision module 120 for determining the risk assessment decision, as described above.

### Decision Tree Models

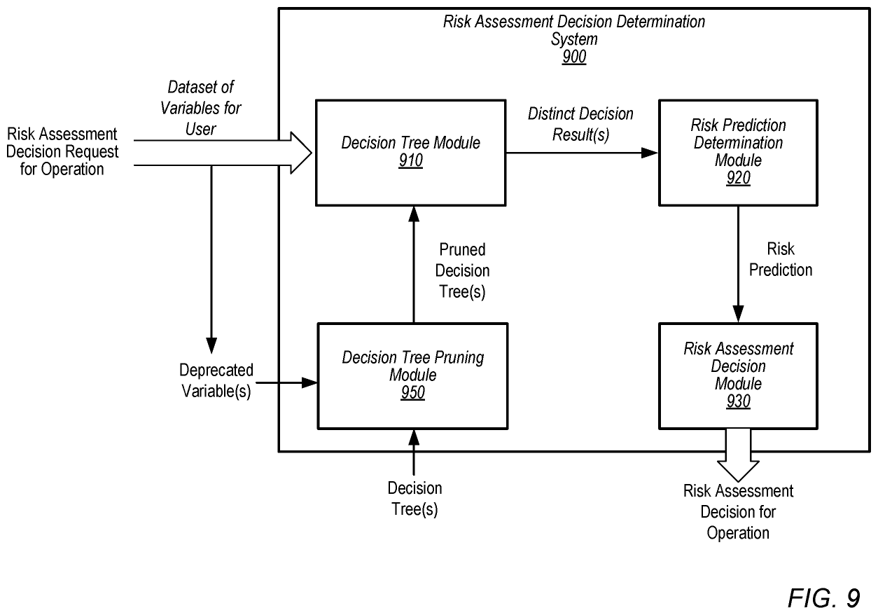

FIG. 9 is a block diagram of a system configured to determine a risk assessment decision using decision trees, according to some embodiments. In the illustrated embodiment, risk assessment decision determination system 900 includes decision tree module 910, risk prediction determination module 920, and risk assessment decision module 930. In various embodiments, decision tree module 910 receives a dataset of variables for a user, for instance, in a request for a risk assessment decision associated with an operation. Decision tree module 910 may determine decision results from the input dataset. In some embodiments, decision tree module 910 may include a single decision tree and provide a single, distinct decision result. In other embodiments, decision tree module 910 may include an ensemble of multiple decision trees where each decision tree determines its own distinct decision result. These distinct decision results may be provided to risk prediction determination module 920. Risk prediction determination module 920 determines a risk prediction (e.g., an overall risk prediction) from the distinct decision results. For example, risk prediction determination module 920 may determine an overall risk prediction based on either an average of the distinct decision results or a majority-vote among the distinct decision results. The (overall) risk prediction is then provided to risk assessment decision module 930, which makes a risk assessment decision for the operation in the request based on the risk prediction.

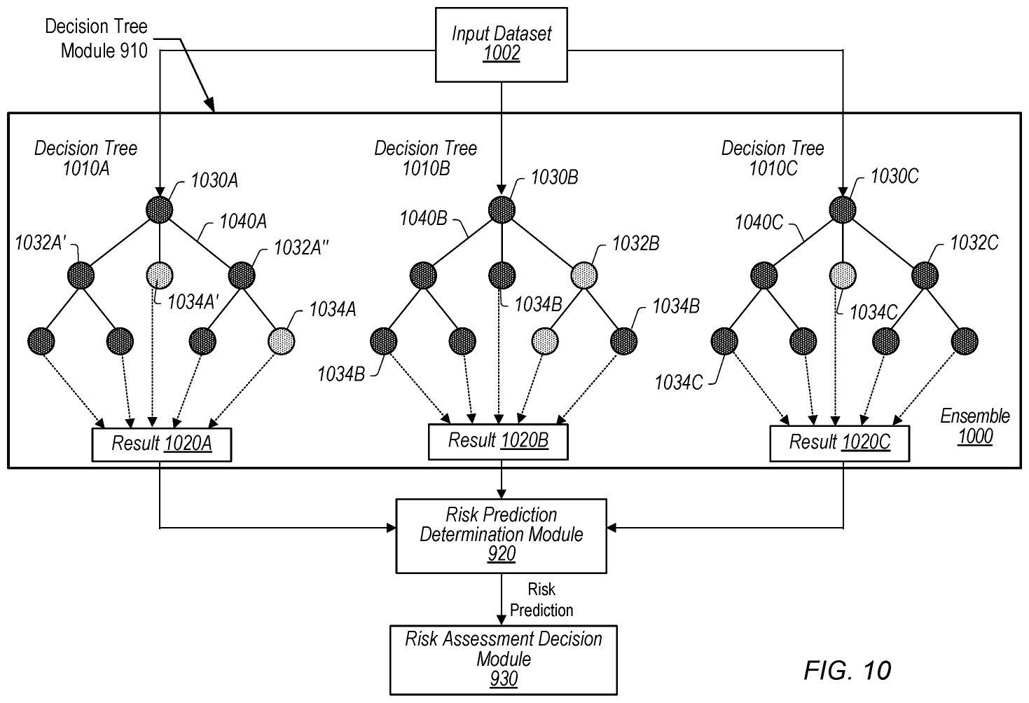

FIG. 10 depicts an example of an ensemble of decision trees, according to some embodiments. In the illustrated embodiment, decision tree module 910 implements decision tree ensemble 1000 to provide decision results for input dataset 1002. Input dataset 1002 may be, for instance, the dataset of variables for a user received by decision tree module 910, as shown in FIG. 9. In the illustrated embodiment, ensemble 1000 has three decision trees 1010A-C determining three distinct decision results 1020A-C, respectively. Ensemble 1000 may, however, have any number of decision trees. In some embodiments, ensemble 1000 may have decision trees 1010 that implement randomized operations on input dataset 1002. For instance, ensemble 1000 may have decision trees 1010 that are randomly generated structures such that the decision trees randomly sample observations (e.g., data from input dataset 1002) and randomly select features when considering splits for various nodes in the decision trees. Final predictions may then be made by averaging or majority-vote of the outputs.

In certain embodiments, decision trees 1010 include various nodes. The nodes may include input nodes 1030 (e.g., root nodes), intermediate nodes 1032 (e.g., branch split nodes), and output nodes 1034 (e.g., leaf nodes). While decision trees 1010 are shown with a single layer of intermediate nodes 1032, it should be understood that any number of intermediate node layers may be implemented between input nodes 1030 and output nodes 1034. The nodes may be interconnected by edges 1040 (e.g., branches of the trees). Each node provides a decision based on a variable in the input dataset to determine which branch (e.g., edge 1040) to go to next based on an assessment of the variable against one or more thresholds. Thus, each input node 1030 or intermediate 1032 may have any number of edges 1040 (e.g., branches) resulting from the node whereas output nodes 1034 are final nodes that provide a terminated decision. As an example, input node 1030A may assess a value with the left edge going to intermediate node 1032A′ is for values below 500, the right edge going to intermediate node 1032A″ is for values above 5000, and the middle edge going to output node 1034A′ is for values in between 500 and 5000. Thus, an input value of 431 would send the next decision to intermediate node 1032A′, which will make a different decision on the input dataset sending the next decision to one of the two downstream output nodes 1034A. The decision made by intermediate node 1032A′ may be implemented on either a different variable or the same variable (e.g., a more refined decision may be made on the same variable).

As shown in FIG. 10, output nodes 1034A-C in decision trees 1010A-1010C provide their outputs to determine results 1020A-C. Results 1020A-1020C may be majority-vote from the various received outputs or may be an average of the received outputs. For example, in the illustrated embodiment, dark circles for output nodes 1034A-C may be a first decision while light circles for output nodes 1034A-C are a second decision. These results 1020A-C are then provided to risk prediction determination module 920, which, based on the received results, outputs a risk prediction to risk assessment decision module 930, as described herein.

In various embodiments, decision tree module 910 operates and determines distinct decision results without any deprecation of variables from the decision trees. For instance, as long as there are no variables deprecated from input dataset 1002, decision tree module 910 operates using all nodes in decision trees 1010 of ensemble 1000. In some embodiments, pruning may be implemented to reduce problems with overfitting of the model. For example, parts of a decision tree (such as branches (edges) and nodes) that do not provide any power (such as weight in the final decision results 1020) may be pruned from the tree. Pruning of these branches and nodes reduces the size of the decision tree without affecting the decision results of the decision tree while improving generalization and operational efficiency of the decision tree. Pruning to remove branches without any power does not, however, accommodate (e.g., provide robustness) for deprecation of variables from datasets provided as input to the decision trees. Thus, if variables are later deprecated (e.g., removed) from datasets provided as input to the decision trees, the decision trees may have decreased accuracy or even break when trying to provide decision results.

The present inventors have recognized that pruning of decision trees based on deprecated variables may advantageously be implemented to overcome issues involved with input datasets having deprecated variables. Turning back to FIG. 9, in certain embodiments, risk assessment decision determination system 900 includes decision tree pruning module 950. In the illustrated embodiment, decision tree pruning module 950 receives as input one or more decision trees and one or more deprecated variables. Decision tree pruning module 950 then prunes the received decision tree(s) based on the received deprecated variable(s). The deprecated variables provided to decision tree pruning module 950 may be variables deprecated according to changes in information, as described herein.

In certain embodiments, as shown in FIG. 9, the deprecated variables are determined based on the dataset of variables received in the risk assessment decision request. For instance, the dataset of variables received may be assessed to determine whether any variables that correspond to nodes in the decision trees have been deprecated. As an example, data for one or more variables that have nodes in the decision trees may not exist in the dataset of variables received and thus, these variables may be determined to be deprecated variables. The variables determined to have been deprecated can then be applied by decision tree pruning module 950 to prune the decision trees, as described herein.

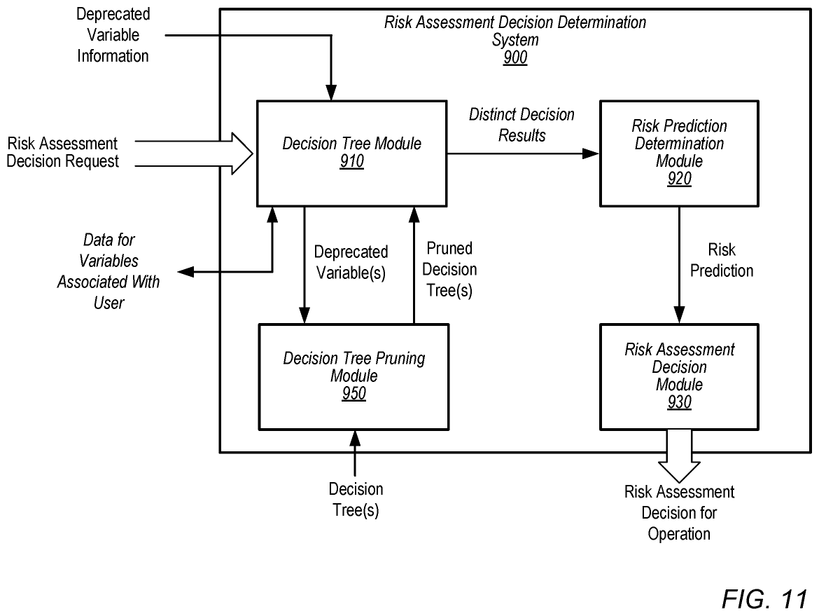

In some embodiments, information about deprecated variables may be independent of the risk assessment decision request. FIG. 11 is a block diagram of a system configured to determine a risk assessment decision using decision trees where deprecated variable information is independent of the request, according to some embodiments. In the illustrated embodiment, decision tree module 910 receives information about deprecated variables independently of the risk assessment decision request. In certain embodiments, decision tree module 910 accesses data for variables associated with the user in response to receiving the risk assessment decision request. The data accessed by decision tree module is determined based on the deprecated variable information. For instance, the data accessed does not include any data for deprecated variables to avoid having unneeded input into the decision trees. Additional embodiments may be contemplated where data for variables associated with the user is included in the request. In such embodiments, decision tree module 910 (or another module in risk assessment decision determination system 900) may remove data corresponding to the deprecated variables from the received data. The data, minus the removed data, may then be operated on by decision tree module to determine decision results.

Regardless of whether the data is received in the request or accessed in response to the request, decision tree module 910 will operate on a set of data that does not include any data for the deprecated variables. In certain embodiments, as shown in FIG. 11, decision tree module 910 provides information on the deprecated variables to decision tree pruning module 950. Decision tree pruning module 950 then prunes the decision trees based on the deprecated variables and provides the pruned decision trees to decision tree module 910 for operation on the data.

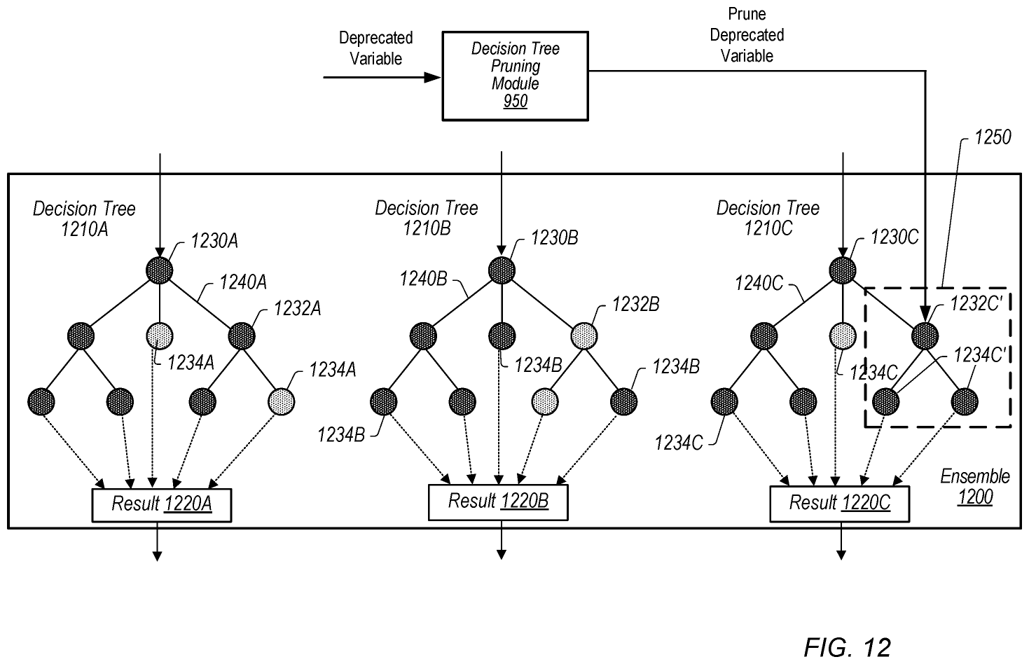

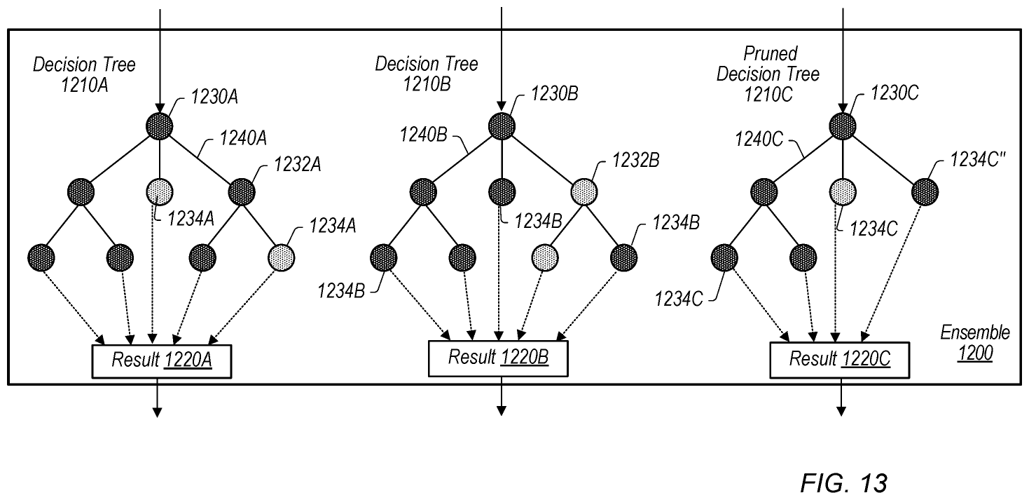

FIGS. 12 and 13 depict examples showing the process of pruning a decision tree that may be implemented by decision tree pruning module 950. FIG. 12 depicts an example of an ensemble of decision trees being operated on by decision tree pruning module 950, according to some embodiments. In the illustrated embodiment, ensemble 1200, which may be implemented in decision tree module 910, has three decision trees 1210A, 1210B, and 1210C. Decision trees 1210A-C implement input nodes 1230A-C to receive input data and output results 1220A-C, respectively. Decision trees 1210A-C also include intermediate nodes 1232A-C, output nodes 1234A-C, and edges 1240A-C providing decisions and movement of data between input nodes 1230A-C and results 1220A-C.

In certain embodiments, decision tree pruning module 950 prunes one or more of the decision trees 1210A-C in ensemble 1200 based on receiving information on a deprecated variable. For instance, in the illustrated example, decision tree pruning module 950 may receive information that a variable associated with intermediate node 1232C′ has been deprecated. Decision tree pruning module 950 determines that intermediate node 1232C′ is to be pruned from decision tree 1210C. In certain embodiments, pruning includes removing any downstream decisions from the node and replacing the node with an output node. Accordingly, as shown in FIG. 12, decision tree pruning module 950 identifies that intermediate node 1232C′ and its two downstream output nodes 1234C′ are to be pruned, as shown by the dashed lines of box 1250. It should be noted that in the illustrated example of FIG. 12, only intermediate node 1232C′ is associated with the deprecated variable and that embodiments may be contemplated where more than one node is associated with the deprecated variable. In such embodiments, pruning will be implemented at each of the nodes associated with the deprecated variable.

FIG. 13 depicts ensemble 1200 from FIG. 12 after the pruning operation has been completed, according to some embodiments. As shown in FIG. 13, after intermediate node 1232C′ and its two downstream output nodes 1234C′ are pruned, the intermediate node is replaced with output node 1234C″. The decision result from output node 1234C″ is then provided to result 1220C and decision tree 1210C is now a pruned decision tree. In certain embodiments, output node 1234C″ provides an output decision that is determined from previous decisions at intermediate node 1232C′. For instance, output node 1234C″ may provide an output decision that is based on a majority of the previous decision results at intermediate node 1232C′. In the illustrated example, a majority of the previous decision at intermediate node 1232C′ provided a dark circle decision result and thus output node 1234C″ has a dark circle decision result that is output to result 1220C. In some embodiments, output node 1234C″ may provide an output decision that is based on an average of the previous decision results at intermediate node 1232C′.

In various embodiments, pruning of additional branches may be implemented by decision tree pruning module 950 for other deprecated variables receiving by the decision tree pruning module. Thus, decision tree pruning module 950 may prune any number of decision trees and any number of branches according to the deprecated variables. After pruning, ensemble 1200 (and its decision trees 1210A-C) may be provided to decision tree module 910 by decision tree pruning module 950, as shown in FIGS. 9 and 11. With pruned decision trees implemented by decision tree module 910 for any deprecated variables, the decision tree module may operate on a dataset having deprecated variables without breaking down or providing inconsistent results. In some embodiments, decision trees can be pruned for both deprecated variables and branches without power in making decisions.

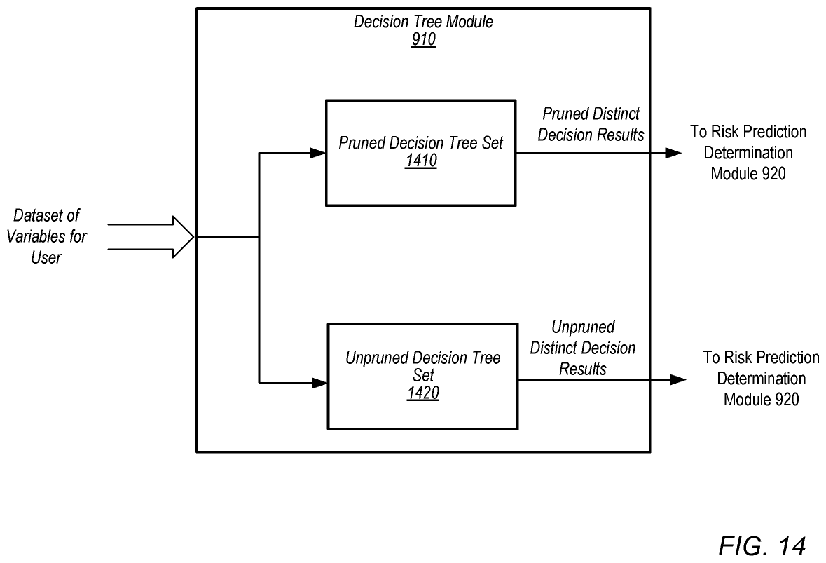

In various embodiments, decision tree module 910 operates with a combination of pruned and unpruned decision trees. FIG. 14 depicts a block diagram of a decision tree module operating on both pruned and unpruned decision trees, according to some embodiments. In the illustrated embodiment, decision tree module 910 includes a set of pruned decision trees 1410 (e.g., a set of decision trees pruned by decision tree pruning module 950) and a set of unpruned decision trees 1420. In some embodiments, pruned decision tree set 1410 includes any decision trees pruned for deprecated variables or pruned for branches without decision power. Unpruned decision tree set 1420 may then include any decision trees that are not pruned by decision tree pruning module 950.

As shown in FIG. 14, the dataset of variables is provided to both pruned decision tree set 1410 and unpruned decision tree set 1420. The distinct decision results provided by these sets are then both provided to risk prediction determination module 920. In various embodiments, both pruned decision trees and unpruned decision trees are part of the same ensemble of decision trees. For instance, as shown in the example of FIG. 13, ensemble 1200 includes pruned decision tree 1210C and unpruned decision trees 1210A, 1210B. As might be expected, unpruned decision trees 1210A, 1210B may operate on a dataset with deprecated variables without breaking down since these decision trees do not have any nodes associated with the deprecated variables. Accordingly, since decision trees that have nodes associated with the deprecated variables have been pruned, decision tree module 910, shown in FIGS. 9, 11, and 14, operates on datasets with deprecated variables without breaking down.

### Example Methods

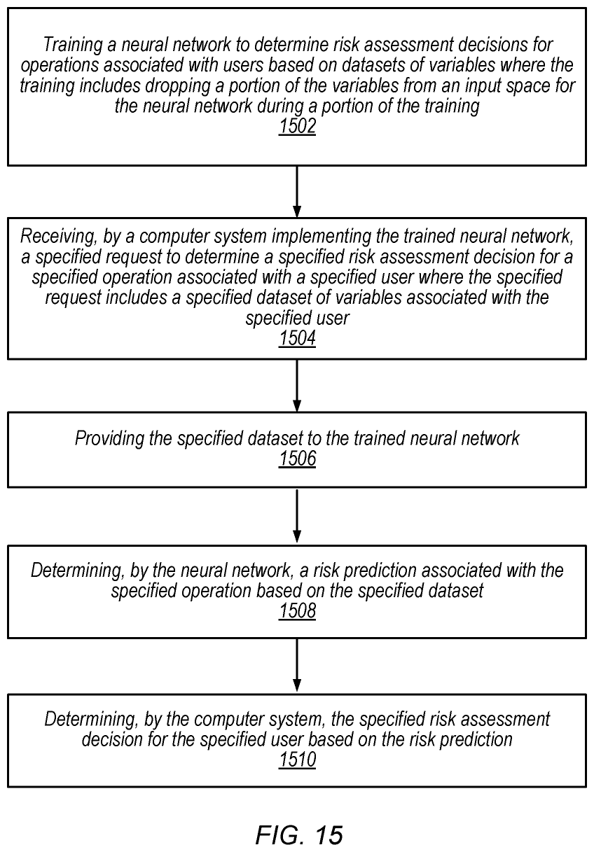

FIG. 15 is a flow diagram illustrating a method for determining a risk assessment decision, according to some embodiments. The method shown in FIG. 15 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In various embodiments, some or all elements of this method may be performed by a particular computer system.

At 1502, in the illustrated embodiment, a neural network is trained to determine risk assessment decisions for operations associated with users based on datasets of variables where the training includes dropping a portion of the variables from an input space for the neural network during a portion of the training.

In some embodiments, training the neural network includes training, with a training dataset that indicates values for a set of variables corresponding to one or more classification categories and known labels for one or more subsets of the training data set, to generate a predictive score indicative of whether an unclassified item corresponds to at least one classification category based on the values for the set of variables and the known labels and generating a set of trained parameters for determining a risk prediction output for an unknown dataset of variables. In some embodiments, dropping the portion of the variables from the input space includes ignoring the variables in the input space and ignoring their downstream edges. In some embodiments, dropping the portion of the variables from the input space includes determining a set of variables to be dropped from the input space and randomizing variables from the set of variables that are ignored in the input space.

At 1504, in the illustrated embodiment, a computer system implementing the trained neural network receives a specified request to determine a specified risk assessment decision for a specified operation associated with a specified user where the specified request includes a specified dataset of variables associated with the specified user.

At 1506, in the illustrated embodiment, the specified dataset is provided to the trained neural network.

At 1508, in the illustrated embodiment, a risk prediction associated with the specified operation based on the specified dataset is determined by the neural network. In some embodiments, the risk prediction is adjusted based on a dropped variable factor where the dropped variable factor is based on a number of variables in the portion of variables dropped during the portion of the training. In some embodiments, the specified dataset has a specified number of deprecated variables and the risk prediction is adjusted based on both the dropped variable factor and a deprecated variable factor based on the specified number of deprecated variables.

At 1510, in the illustrated embodiment, the computer system determines the specified risk assessment decision for the specified user based on the risk prediction.

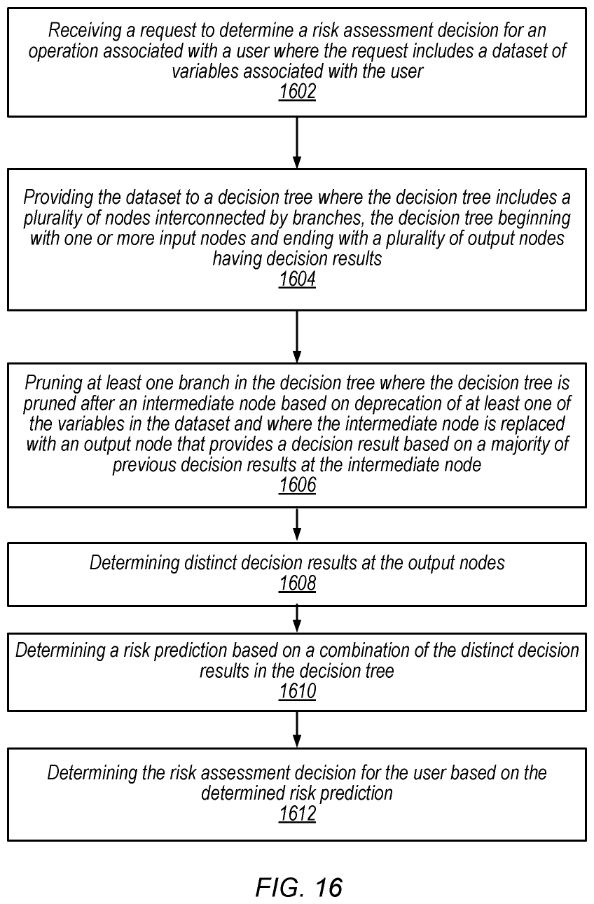

FIG. 16 is a flow diagram illustrating another method for determining a risk assessment decision, according to some embodiments. The method shown in FIG. 16 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In various embodiments, some or all elements of this method may be performed by a particular computer system.

At 1602, in the illustrated embodiment, a computer system receives a request to determine a risk assessment decision for an operation associated with a user, wherein the request includes a dataset of variables associated with the us.

At 1604, in the illustrated embodiment, the dataset is provided to a decision tree where the decision tree includes a plurality of nodes interconnected by branches, the decision tree beginning with one or more input nodes and ending with a plurality of output nodes having decision results. In some embodiments, at least one variable is deprecated in the dataset of variables in the request where the at least one variable is deprecated based on changes in information available for determining the risk assessment decision and the decision tree is pruned after the intermediate node where the intermediate node for the pruning is a node providing a decision result based the at least one deprecated variable.

At 1606, in the illustrated embodiment, at least one branch in the decision tree is pruned where the decision tree is pruned after an intermediate node based on deprecation of at least one of the variables in the dataset and where the intermediate node is replaced with an output node that provides a decision result based on a majority of previous decision results at the intermediate node. In some embodiments, the dataset of variables in the request has at least one deprecated variable removed from the dataset where the at least one branch in the decision tree is pruned in response to the receiving the dataset with the at least one deprecated variable. In some embodiments, the intermediate node for the pruning is a node providing a decision result based on the at least one deprecated variable.

In some embodiments, pruning the at least one branch in the decision tree includes removing nodes that are downstream of the intermediate node on the pruned branch.

At 1608, in the illustrated embodiment, distinct decision results are determined at the output nodes. In some embodiments, the decision tree includes a plurality of branches with intermediate nodes providing decision results based on the at least one deprecated variable and each of the branches in the decision tree is pruned where the decision trees are pruned after the intermediate nodes providing decision results based on the at least one deprecated variable and where the intermediate nodes are replaced with output nodes that provide decision results based on majorities of previous decision results at the intermediate nodes.

At 1610, in the illustrated embodiment, a risk prediction is determined based on a combination of the distinct decision results in the decision tree. In some embodiments, the risk prediction is determined by averaging the distinct decision results in the decision tree. In some embodiments, the risk prediction is determined by determining a majority decision result from the distinct decision results in the decision tree.

At 1612, in the illustrated embodiment, the risk assessment decision is determined for the user based on the determined risk prediction for the user.

### Example Computer System

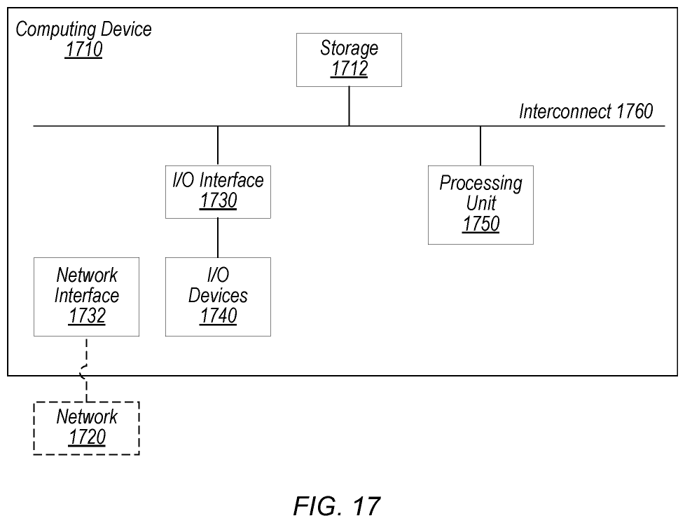

Turning now to FIG. 17, a block diagram of one embodiment of computing device (which may also be referred to as a computing system) 1710 is depicted. Computing device 1710 may be used to implement various portions of this disclosure. Computing device 1710 may be any suitable type of device, including, but not limited to, a personal computer system, desktop computer, laptop or notebook computer, mainframe computer system, web server, workstation, or network computer. As shown, computing device 1710 includes processing unit 1750, storage 1712, and input/output (I/O) interface 1730 coupled via an interconnect 1760 (e.g., a system bus). I/O interface 1730 may be coupled to one or more I/O devices 1740. Computing device 1710 further includes network interface 1732, which may be coupled to network 1720 for communications with, for example, other computing devices.

In various embodiments, processing unit 1750 includes one or more processors. In some embodiments, processing unit 1750 includes one or more coprocessor units. In some embodiments, multiple instances of processing unit 1750 may be coupled to interconnect 1760. Processing unit 1750 (or each processor within 1750) may contain a cache or other form of on-board memory. In some embodiments, processing unit 1750 may be implemented as a general-purpose processing unit, and in other embodiments it may be implemented as a special purpose processing unit (e.g., an ASIC). In general, computing device 1710 is not limited to any particular type of processing unit or processor subsystem.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Storage 1712 is usable by processing unit 1750 (e.g., to store instructions executable by and data used by processing unit 1750). Storage 1712 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage 1712 may consist solely of volatile memory, in one embodiment. Storage 1712 may store program instructions executable by computing device 1710 using processing unit 1750, including program instructions executable to cause computing device 1710 to implement the various techniques disclosed herein.

I/O interface 1730 may represent one or more interfaces and may be any of various types of interfaces configured to couple to and communicate with other devices, according to various embodiments. In one embodiment, I/O interface 1730 is a bridge chip from a front-side to one or more back-side buses. I/O interface 1730 may be coupled to one or more I/O devices 1740 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, by a computer system, a request to determine a risk assessment decision for an operation associated with a user, wherein the request includes a dataset of variables associated with the user;
providing the dataset to a decision tree, wherein the decision tree includes a plurality of nodes interconnected by branches, the decision tree beginning with one or more input nodes and ending with a plurality of output nodes having decision results;
pruning at least one branch in the decision tree, wherein the decision tree is pruned after an intermediate node based on deprecation of at least one of the variables in the dataset, and wherein the intermediate node is replaced with an output node that provides a decision result based on a majority of previous decision results at the intermediate node;
determining distinct decision results at the output nodes;
determining a risk prediction based on a combination of the distinct decision results in the decision tree; and
determining, by the computer system, the risk assessment decision for the user based on the determined risk prediction for the user.

2. The method of claim 1, wherein the dataset of variables in the request has at least one deprecated variable removed from the dataset, and wherein the at least one branch in the decision tree is pruned in response to the receiving the dataset with the at least one deprecated variable.

3. The method of claim 2, wherein the intermediate node for the pruning is a node providing a decision result based on the at least one deprecated variable.

4. The method of claim 1, further comprising:
deprecating at least one variable in the dataset of variables in the request, wherein the at least one variable is deprecated based on changes in information available for determining the risk assessment decision; and
pruning the decision tree after the intermediate node, wherein the intermediate node for the pruning is a node providing a decision result based the at least one deprecated variable.

5. The method of claim 1, wherein the decision tree includes a plurality of branches with intermediate nodes providing decision results based on the at least one deprecated variable, the method further comprising:
pruning each of the branches in the decision tree, wherein the decision trees are pruned after the intermediate nodes providing decision results based on the at least one deprecated variable, and wherein the intermediate nodes are replaced with output nodes that provide decision results based on majorities of previous decision results at the intermediate nodes.

6. The method of claim 1, wherein pruning the at least one branch in the decision tree includes removing nodes that are downstream of the intermediate node on the pruned branch.

7. The method of claim 1, wherein the risk prediction is determined by averaging the distinct decision results in the decision tree.

8. The method of claim 1, wherein the risk prediction is determined by determining a majority decision result from the distinct decision results in the decision tree.

9. The method of claim 1, further comprising pruning, after a set of decision results, one or more branches in the decision tree that lack prediction power in the set of decision results.

10. The method of claim 1, wherein the decision tree includes a random application of the variables at the input nodes and random application of the variables to branches interconnected to the nodes.

11. A non-transitory computer-readable medium having instructions stored thereon that are executable by a computing device to perform operations, comprising:
receiving a request to determine a risk assessment decision for an operation based on a plurality of variables associated with a user;
accessing data for the variables associated with the user;
providing the data to a set of decision trees, wherein the decision trees include pluralities of nodes interconnected by branches, the decision trees beginning with input nodes and ending with output nodes having decision results;
pruning at least one branch in at least one decision tree in the set of decision trees, wherein the at least one decision tree is pruned after an intermediate node based on deprecation of at least one of the variables in the data, and wherein the intermediate node is replaced with an output node that provides a decision result based on a majority of previous decision results at the intermediate node;
determining distinct decision results at the output nodes;
determining a risk prediction based on a combination of the distinct decision results in the set of decision trees; and
determining the risk assessment decision for the user based on the determined risk prediction for the user.

12. The non-transitory computer-readable medium of claim 11, wherein the data for the variables is accessed in response to receiving the request.

13. The non-transitory computer-readable medium of claim 11, further comprising:
determining that at least one variable from the variables associated with the user is deprecated; and
accessing the data for the variables associated with the user, wherein the accessed data does not include data for at least one deprecated variable.

14. The non-transitory computer-readable medium of claim 13, wherein the at least one decision tree is pruned after the intermediate node based on the intermediate node providing a decision result based on the at least one deprecated variable.

15. The non-transitory computer-readable medium of claim 11, further comprising:
receiving changes in information available for determining the risk assessment decision;
deprecating at least one variable in the accessed data for the variables associated with the user, wherein the at least one variable is deprecated based on changes in information available for determining the risk assessment decision; and
pruning the decision tree after the intermediate node based on the intermediate node providing a decision result based on the at least one deprecated variable.

16. A method, comprising:
receiving, by a computer system, a request to determine a risk assessment decision for an operation associated with a user, wherein the request includes a dataset of variables associated with the user, and wherein the dataset of variables in the request has at least one deprecated variable removed from the dataset;
providing the dataset to a set of decision trees, wherein the decision trees include pluralities of nodes interconnected by branches, the decision trees beginning with input nodes and ending with output nodes having decision results, and wherein distinct decision results for the decision trees are determined based on the decision results at the output nodes, and wherein the set of decision trees includes at least:
a first decision tree having at least one branch pruned after an intermediate node that provides a decision result based on the at least one deprecated variable, the node at an end of the pruned branch providing a decision result based on a majority of previous decision results at the intermediate node; and
a second decision tree without any intermediate nodes that provide decision results based on the at least one deprecated variable;
determining a risk prediction based on a combination of the distinct decision results in the set of decision trees; and
determining, by the computer system, the risk assessment decision for the user based on the determined risk prediction.

17. The method of claim 16, wherein the set of decision trees includes:
a third decision tree having two or more branches pruned after intermediates node that provide decision results based on the at least one deprecated variable, the nodes at ends of the pruned branches providing decision results based on majorities of previous decision results at the intermediate nodes.

18. The method of claim 16, wherein the risk prediction is determined by averaging the distinct decision results in the set of decision trees.

19. The method of claim 16, wherein the risk prediction is determined by determining a majority decision result from the distinct decision results in the set of decision trees.

20. The method of claim 16, further comprising:
receiving, by the computer system, a second request to determine a second risk assessment decision for a second operation associated with a second user, wherein the request includes a second dataset of variables associated with the second user, and wherein the second dataset of variables in the second request has a second deprecated variable removed from the second dataset, the second deprecated variable being different than the at least one deprecated variable;
providing the dataset to the set of decision trees, wherein the set of decision trees includes:
a third decision tree having at least one branch pruned after an intermediate node that provides a decision result based on the second deprecated variable, the node at an end of the pruned branch providing a decision result based on a majority of previous decision results at the intermediate node;
determining a second risk prediction based on the combination of the distinct decision results in the set of decision trees; and
determining, by the computer system, the second risk assessment decision for the second user based on the second determined risk prediction.
